(19) United States
(12) Patent Application Publication
(10) Pub. No.: US 2005/0239620 A1
(43) Pub. Date: Oct. 27, 2005

(54) Machine tool with a work spindle

(76) Inventors: Heinrich Lutz, Dirlewang (DE); Anton Kienle, Salgen (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 11/068,774

(22) Filed: Mar. 2, 2005

(30) Foreign Application Priority Data
Mar. 3, 2004 (DE) 10 2004 010 978.8
Jun. 28, 2004 (DE) 10 2004 031 066.1

(51) Int. Cl. B23Q 3/157

(52) U.S. Cl. 483/63

(57) ABSTRACT

The invention refers to a machine tool with only one work spindle which carries and drives an exchangeable machining tool. Furthermore a tool supply is provided which has tool tongs for receiving machining tools. For exchanging and replacing the machining tools a relative movement is provided. It is suggested to share out the tool supply between at least two partial magazines.

The invention refers to a machine tool with a work spindle which has a tool supply which has tool tongs for receiving machining tools, a relative movement between tool magazine and work spindle being provided for exchanging, respectively replacing, machining tools on the work spindle.

### BACKGROUND OF THE INVENTION

So-called one-spindle machine tools are sufficiently known. Also multi-spindle machine tools are known. In these in a machine tool a work spindle is provided. The machine tools of this type are often used for cutting machining. The advantage of these machine tools is the high cutting capacity.

For replacing, respectively exchanging, machining tools on the work spindles a procedure known as “pick-up technique” is used. It is known to design the tool magazine stationary for the tool change procedure, and the work spindle moves towards the tool magazine. For putting-in or removing the tool a relative movement between the tool magazine disc and the work spindle is required, which is derived, for example, from the movement of the work spindle.

A machine tool of the kind described before is designed, for example, as two-spindles machine tool with two-disc magazine. A machine tool is provided here where on one machine column two headstocks are provided with one work spindle each which can be shifted independently of each other in vertical and horizontal direction. On the top surface of the machine column there is a tool storage comprising two disc or plate magazines independent of each other and arranged close to each other. The disc or plate magazines have tongs-like receivers for holding machining tools. These two-spindles machine tools, however, are considerable more expensive to manufacture and to maintain then one-spindle machines.

Another device for machining work pieces is known from the state of the art. This device has a stand on which at least one spindle head with a work spindle is supported which can be adjusted in at least one direction. The device also has at least one tool change magazine from which tools can be taken and in which tools can be deposited.

In the state of the art a machine tool is known. In this machine tool with a one- or multi-spindle unit for picking up tools which can be shifted in preferably three directions of axis, as well as with a tool magazine, the tool magazine and the one- or multi-spindle unit can be moved in order to change the tools at least at times simultaneously relatively to each other.

For an application of the machine tool as efficient as possible it is known to provide tool magazines which pick up tools redundantly, in order, for example, to exclude an interruption of the machining when the tools are worn. Of course, the tool magazine also serves for providing a plurality of different machining tools for different machinings on the work spindle.

Machine tools of this kind therefore have to be designed in such a way that a number of machining tools as high as possible is available.

### BRIEF ABSTRACT OF THE INVENTION

It is an object of the invention to provide machine tools as described in the beginning, which have a density of tools in their tool magazines as high as possible.

The problem according to the invention is solved, as described above, by a machine tool which has only one work spindle which carries and drives a machining tool which can be exchanged, as well has a tool supply which has tool tongs for receiving machining tools. Even with such an alternative machine tool a relative movement between tool magazine and work spindle is provided for exchanging, respectively replacing, machining tools at the work spindle. In order to solve the problem according to the invention it is suggested here that the tool supply is shared out between at least two partial magazines. Eventually it is decisive to optimise the available circumference while the surface or the extension of the tool supply is as minimal as possible. It is therefore more convenient to share out the tool supply between two partial magazines then to realise the complete surface in one magazine. The result are clearly smaller partial units which can be handled easier and which can be also manufactured more economically. The suggestion optimises the available number of tongs considerably.

In a modification it is suggested here that the partial magazine is designed as a tool magazine disc rotating around a rotational axis. According to this variant it is suggested to use in the same way a tool magazine disc as partial magazine in the sense of this part of the invention.

The single work spindle may be designed here mobile in such a way that it can reach the respective partial magazines distanced from each other. In the sense of the invention it is possible here to design the partial magazine either as tool magazine disc or even as chain magazine or the like. Here, for example, the anyway present, big lifting movement of suitable machine tools during the tool change is used again in order to reach the partial magazines far away.

Alternatively it is, of course, also possible that the partial magazines can be shifted and be brought to the work spindle in order to carry out the tool change.

It is convenient that the partial magazines are arranged above the work spindle. However, they may also be arranged on the side of the work spindles or below them. In this respect the invention is not limited. Furthermore all other references and also all other possible combinations of features go for this part of the invention; it is, in particular, possible to arrange tool tongs radially or at a certain angle on the partial magazines designed as tool magazine disc.

The problem is also solved by a machine tool as described, and it is provided there that the tongs axis of the tool tongs is arranged on the respective tool magazine disc radially, respectively the tongs axis forms an acute angle alpha with the connection line between the rotational axis and the tool magazine disc, and the tool axis of the machining tool resting in the tool tongs.

The tool tongs is formed by a receiver which interacts with the shank of the machining tool. Furthermore suitably designed holding devices are provided which guarantee that the machining tool is held securely in the tool tongs and cannot fall out unintentionally. The tool tongs here do not require necessarily two tongs claws interacting with each other, the term tool tongs is meant rather as generic term describing every possibility of picking up and holding machining tools in the tool magazine discs of the machine tools of this kind.

The tool tongs have a certain longitudinal extension. This longitudinal extension is often also the symmetric axis of the tool tongs. In this respect the main direction of this longitudinal extension is seen as tongs axis which coincides in a special modification of the invention with the symmetric axis of the tool tongs. Therefore, however, the tongs axis is defined in such that the tool axis, that is the rotational axis of the machining tool and the center of gravity of the tool tongs are part of the tongs axis.

The tool tongs is here designed so slim that it tapers accordingly to the inside, that is away from the machining tool, so that the arrangement of the machining tool on the circumference of the tool magazine disc is carried out in a density as high as possible as by providing a high number of tool tongs, of course, also a high number of machining tools can be stored on the tool magazine disc.

A similarly advantageous arrangement is also the one where the tongs axis forms an acute angle with the connection line between the rotational axis of the tool magazine disc and the tool axis of the machining tool resting in the tool tongs. A certain tilting in the direction of the respective tangent (relative to the rotational axis) reduces unmeasurably the storage capacity of the tool magazine disc for tools, however, offers certain advantages for loading and unloading the tools in the spindle. In particular, if the spindles are positioned close to each other it is also possible by means of such an arrangement to exchange simultaneously the tools of several spindles.

The invention here makes several different constructive suggestions. First of all, it is possible that the machine tool according to the invention provides for at least two machining spindles two (or even more) tool magazine discs. Conveniently the work spindles here are shared out between a suitable number of work spindle groups, the number of these groups corresponds with the number of tool magazine discs.

In the sense of the invention it is irrelevant here whether the number of work spindles per group is identical or differs. Both variants are possible here.

Compared with the solutions known from the state of the art the invention has the advantage that a tool change is made considerably easier by the particular way of arrangement in the tool magazine, in particular the storing in specially designed and specially arranged tool tongs. The tool change is carried out essentially faster and has the advantage to be little prone to malfunctions. In the solutions known from the state of the art the tool receivers are either designed only tongs-like, or they have tongs which are arranged for a change in an inconvenient manner, or they themselves are designed in such a way that the tool change is only possible in certain positions. This procedure is quite expensive and frequently leads to malfunctions. Additionally the loss of time is considerable through this procedure. The invention removes the described disadvantages by arranging the tongs axis of the tool tongs on the respective tool magazine disc radially, respectively by the fact that the tongs axis forms an acute angle with the connection line between the rotational axis of the tool magazine disc and the tool axis of the machining tool resting in tool tongs. The solutions known from the state of the art are also characterized by a disadvantageous angle of the arrangement of the tool tongs, respectively the tool receivers.

The other constructive modification possible according to the invention is an arrangement where one disc is provided for a plurality of spindles, respectively spindle groups, or for all work spindles of a machine tool. The problem according to the invention is thus solved in many differing ways. The invention achieves here that a large number of machining tools are provided without enlarging the floor space required by the machine tool.

This effect is increased if, in a modification of the invention, it is provided that the tool magazine discs are arranged above the work spindle. Usually the space above the machine tool is not used, however, the floor space of the hall is quite restricting for the number of machine tools, in particular, if they have to be interlinked. Advantageously therefore the tool magazine discs are arranged above the work spindles, and taken to the work spindle on demand.

In a preferred modification of the invention it is provided the machine tool has two tool magazine discs which stand close to each other at least in the tool change position.

The tool change position is here the arrangement in which the tool change takes place, that is the tool magazine disc is at the respective work spindle in order to exchange the tool.

The orientation of the tool magazine discs close to each other, at least during the tool change, makes it possible with two tool magazine discs at two work spindles or groups of work spindles, which are also orientated close to each other, to change the tools simultaneously. This increases the efficiency as the change process is carried out for all work spindles simultaneously.

This modification according to the invention makes here also several designs possible. First of all, it is possible that both tool magazine discs are shifted essentially parallel, and thus actually the whole time, as well as during the change process, are arranged relatively close to each other. By such a design it is, for example, possible, to provide a common drive for the tool magazine discs.

In another modification it is possible that the tool magazine discs are provided in waiting positions far away from each other, outside the working area, and are brought in the tool position only for the tool change, as described. This modification makes it possible to carry out the tool exchange in the waiting position economically favorably as, for example, tool magazine discs are shifted accordingly to the outside where they are reached easily by the staff.

In a preferred modification of the invention it is provided that the two rotational axes of the two tool magazine discs are orientated parallel and/or the two tool magazine discs are in one plane. By such a design the construction is made easier, as also the work spindles are supported in the space in the same way and are often moved in the same way. The control of the complete machine tool according to the invention is made easier by that accordingly. This arrangement also achieves that the tool axes are parallel to the axes, and thus the exchange, respectively the replacing, of the tools is possible in a simple manner. In the same way it is also an advantage if the two tool magazine discs are in the same plane. Exactly if the work spindles are designed and installed identically, a simple geometric relation is made by that, and, in particular, the common exchange is made easier which leads to a corresponding time saving.

The invention does not exclude here solutions in which the geometric relations mentioned before do not exist. Of course, also arrangements belong to the scope of the invention where the rotational axes are not parallel to each other, or the tool magazine discs are tilted to each other or arranged in parallel planes.

It is an advantage here that the invention provides that the first tool magazine disc is assigned to the first work spindle, respectively a first group of work spindles, and also the second tool magazine disc to the second work spindle, respectively a second group of work spindles. Such an arrangement can be realized, of course, also with more than two tool magazine discs without any problems. These partial systems are then synchronized to each other, and, if necessary, designed again redundant in themselves.

It is an advantage if for the tool magazine discs a guide is provided along which the tool magazine disc can be moved linear in a linear movement, and can be brought to the work spindle in a tool change position. Different modifications are possible for the design of the guide. In particular, such a design has the advantage that the tool magazine disc can be brought in a waiting position outside the working area, and be parked there where it does not interfere. Alternatively it is, of course, possible not to move the tool magazine disc, but to bring the work spindles to the tool magazine disc. These kinematic surroundings also belong to the invention. It is also provided here that the linear movement is also used for carrying out in a relative movement for replacing, respectively exchanging, the machining tools. In particular sharing out the different axes of movement between different elements saves effort as an orthogonal movement of elements, for example the cross table for work spindles, is accordingly expensive.

In view of the construction it is provided here that a slide moves on the guide, and the tool magazine disc is on the slide. In another embodiment of the invention it is possible here that several tool magazine discs can be moved in a common guide identically. For example, a slide beam is provided which can be moved on the guide, and the slide beam carries two or more tool magazine discs. Such an arrangement can be used, for example, when both tool magazine discs have to be approached simultaneously for the replacing/exchanging procedure. The effort for the drive is cut in two.

Besides this dependent movement of the tool magazine discs it is, in an alternative, provided according to the invention that several tool magazine discs can move independently of each other. For that purpose then suitable individual drives and also guides, respectively guide elements like slides, are provided. It is also pointed out here that an identical as well as an independent movement of the work spindles belongs to the invention in the same way.

Furthermore, besides a parallel guide of several tool magazine discs, it is, according to the invention, also provided that each of several tool magazine discs has its own guide, and the respective directions for movement form with each other an angle, in particular an obtuse or an acute angle, as it is indicated, for example, in FIG. 6 or FIG. 8. Such a design has the result that the tool magazine discs can be brought closely to each other for the change process, and in this way serve work spindles standing also closely to each other, however, then are removed far away from each other for the waiting position, and thus, for example, are easily accessible for maintaining the tools by the staff. The diagonal arrangement of these different guides, however, has advantages for exchanging and replacing the tools themselves, as it will be described further down, in particular if the distance between the spindles with respect to the diameter of the tool magazine disc is small. Also a solution where the tool magazine discs drift apart diametrically, that means at an angle of 180°, be it in vertical, horizontal or diagonal direction, belongs to the invention.

In a preferred modification of the invention it is provided that the tool magazine disc is designed like a ring, and has a rotational drive. Conveniently here the rotational drive is set in the opening of the ring, and thus a drive as balanced as possible is realized. Alternatively to that it is possible to realize the tool magazine disc as actually plate-like, continuous disc, and to arrange the drive on the shaft forming the rotational axis.

According to the invention it is possible to design the rotational drive individually for each tool magazine disc, which makes it possible to position several tool magazine discs each independently of each other. Alternatively it is also possible to couple these rotational drives accordingly in order to optimize also the rotational drive by this.

In a modification of the invention it is provided that the tool magazine disc is designed as polygon. According to his modification of the invention it becomes evident that by the formulation as tool magazine disc not expressly a circular design is provided but this disc may actually be designed as polygon. Such a design has advantages in the production. A big advantage according to the invention is the fact that the tool tongs are arranged in a circle concentrically around the rotational axis. By such an arrangement a high density of tools is reached on the tool magazine disc. The single tool tongs have to be arranged space-saving one beside the other, and all tool tongs are located ideally at the same positioning of the tool magazine disc at the respective same place when the machining tool has to be replaced.

In a preferred modification of the invention it is provided that in the tool change position the spindle axis of the work spindle and the rotational axis form a straight line parallel to the linear movement. In this preferred case of the invention the linear movement of the tool magazine disc serves as movement in order to either pick up the machining tool out of the tool tongs or to deposit it there. Particularly clever is such an arrangement if the guide of the tool magazine disc is tilted, as for example indicated in FIG. 6. The arrangement is provided here such that—although relatively large tool magazine discs are used—the movement of the tool magazine disc can be used directly in order to pick up or deposit the machining tool.

Alternatively to that it is provided that in the tool change position the connection line of the spindle axis of the work spindle and the rotational axis forms an acute angle with the linear movement. In this case differing from the previously described one it is even possible to remove the tool directly from the tool tongs or to deposit it there. This is favored by a design of the tool tongs adapted to this. Such a design is shown, for example, in FIG. 8 where such a modification becomes important in particular if two spindles are supposed to be loaded, respectively unloaded, by one tool magazine disc.

In another modification according to the invention it is suggested that he relative movement results from an interference of at least two movements, for example of the tool magazine disc and/or the work spindle. It is not only provided, according to the invention to derive the relative movement, which serves for exchanging and replacing the machining tool, only from one movement, for example of the tool magazine disc or the work spindle, but, according to the invention, the interference of two movements and the resulting alternative movement is used. By a clever interference of these movements, namely a resultant is achieved which is in the orthogonal field of the two single movements. By selecting the respective speeds of the single movements the orientation of the resultant can be adjusted. Here even different movements of one and the same element, for example of the tool magazine disc, can be interfered in the sense of the invention.

In a particular embodiment of the suggestion mentioned above it is provided in another modification according to the invention that the relative movement results from interference of the linear movement of the tool magazine disc and a linear movement of the work spindle. In such a design, of course, a certain mobility of the work spindle is required; this mobility should be, for example, parallel to the plane where the tool magazine disc is located.

However, if it is possible to do without a separate drive for the movement, respectively positioning, of the spindle, as it is, for example, possible with arrangements where the work piece is moved, another modification according to the invention suggests that the relative movement results from an interference of the linear movement of the tool magazine disc and a rotation of the tool magazine disc around its rotational axis. The required drives which are present anyway are thus used one more time surprisingly convenient. The linear movement, which is required anyway for approaching the tool magazine disc, as well as the rotational drive which is provided for selecting and positioning the desired tool tongs with the desired machining tool, is thus used one more time, connected with each other only with a suitably small effort of programming.

According to another modification of the invention it is provided that several work spindles are combined to a group of work spindles and, if necessary, are also stored in a common headstock. It is, in particular, provided that the work spindles are shared out between two groups of spindles, a first and a second group of work spindles, and these groups of work spindles can be moved either independently of each other or simultaneously to each other. According to the invention it is possible here to use a central drive for both, respectively all, groups of work spindles. From that results then a respective dependent movement of these two groups. It may be carried out, of course, also in respective different directions, for example with the help of a suitable gear. However, the movement can here be also identical, for example, so that the different groups of work spindles are arranged on a common headstock, and this headstock is once driven commonly centrally. Alternatively it is, of course, also possible that both groups of work spindles have their respective own autonomous drives by means of which the work spindles can each be selected, moved and positioned independently of each other in any way.

In all modifications mentioned above it is, of course, clear that the work spindles, respectively the headstock, is designed slide-like and can be moved on a guide. Of course, this basic mobility makes also a positioning of the work spindles possible, for example for or during machining.

According to the invention it is also suggested that one tool magazine disc supplies one, two or more work spindles with machining tools. According to the invention it is therefore provided that a tool magazine disc supplies also a group of work spindles. Because of the task according to the invention, namely to provide a high density of machining tools, it is now possible by means of the invention, to just provide even a larger number of machining spindles with only one tool magazine disc, for example a tool magazine disc for a group of two or three or even more work spindles. This unit is then, for example, provided in a machine tool according to the invention double, symmetric. The flexibility, but also the efficiency of such a machine tool according to the invention is increased considerably, and it is achieved here to combine in the invention cleverly the features efficiency and flexibility which are otherwise opposed. The invention reaches a high cutting capacity with a large number of machining tools which can be used differently. It has turned out here to be convenient that the tool tongs are arranged on the tool magazine disc in two or more circles. By means of such a clever arrangement of these circles, which are as a rule also concentric (concentric around a rotational axis) the packing density of the tools, respectively the tool tongs, is increased additionally.

Conveniently in another modification of the invention it is suggested that the tool tongs of a circle are assigned to a particular work spindle. It is, of course, possible, to arrange the machining spindles in the respective spindle group, respectively in the headstock, in such a way that they are arranged for the change process each time in the same circle line. As, however, by the multi-line arrangement of the tool tongs the number of the available machining tools can be increased it is convenient to select the arrangement of the tool spindles accordingly so that, for example, a horizontal arrangement of machining spindles, one beside the other, is possible. However, the invention allows any variant of this.

It is in particular also provided that the tool magazine disc has in the region of an interior and/or exterior tool tongs an opening through which the machining tool is guided when it is loaded in or unloaded from the tool magazine disc. This opening is chosen here larger then the receiver of the tongs, and the machining tool is here to be moved essentially parallel to the rotational axis, respectively the spindle axis, which may be realised, however, by the center sleeve drive of the tool spindle, which is provided anyway, in Z-direction or a separate Z-axis for the tool magazine disc in a simple manner in the frame of the machine control.

Of course, the arrangement of the tool tongs on the circumference of the tool magazine disc is chosen in such a way that a free access of the machining tool into the tongs is secured, if necessary, suitable recesses or indentations or even borings are provided in the tool magazine disc.

Another essential advantage of the invention is in particular the fact that with the relative movement the simultaneous change of the machining tools of two or more work spindles is possible. According to the invention it is provided that at least one tool magazine disc changes simultaneously the machining tools of several work spindles. Besides a high density of machining tools, a high variability because of a large number of machining tools the tool change takes only little time through the simultaneous change.

It is conveniently provided that the relative movement is orientated in the space between the tongs axes of the tool tongs which are in tool change position with respect to the respective work spindle. Removing or putting in the machining tool in the tool tongs is carried out here, as already mentioned, along a line which forms an acute angle with the linear movement, however, the respective deviations for the concerned tool tongs, which are as a rule adjacent, are the same. Conveniently here the bisecting line of the angle formed by the respective tongs axes is used for the relative movement.

In another modification according to the invention it is provided that the machine tool has only one tool magazine disc which supplies at least two work spindles with machining tools. Such a design is shown, for example, in FIG. 1 or FIG. 3. The tongs axis here forms an acute angle with the connection line between the rotational axis, the tool magazine disc and the tool axis of the machining tool resting in the tool tongs. This acute angle does not interfere as, in particular, the tool tongs also in the back region are designed securely enough and thus do not interfere with each other. Even with a corresponding small acute angle alpha it remains, according to the invention, possible to provide a high number of machining tools.

In another modification of the invention it has been found that the diameter of the circle in which the tool tongs are arranged is large compared with the distance of the spindle axes. This proportion in size is preferably more than 5. This means the diameter is five times the distance of the spindle axes. According to the invention thus a comparatively large tool magazine disc is proposed which, because of its considerable circumference, serves additionally for receiving a large number of machining tools. An advantageous interval of this proportion of sizes is between 6 and 12. A very good use is made of the space if the diameter is set at about 9 to 10 times in the distance of the spindles, because then the complete width of the machine tool can be used optimally. Besides a large number of machining tools, which may be provided here, also the tilting of the individual tool tongs relatively to the connection line of rotational axis and tool axis is smaller. At this point it is referred also to FIG. 1 as an example.

In another advantageous embodiment of the invention it is suggested that the connection line of the tool axes of two machining tools which are arranged in the respective tool tongs and which are suited to get exchanged in the work spindles simultaneously, is rectangular to the tongs axis of the respective tool tongs. By the linear movement of the tool magazine disc ideally the replacing and exchanging process of the tool is made possible for a plurality of tool tongs. Several possibilities to arrange the machining tools result from that. For example they may be arranged in a sequence as follows: ababcdcdefef, the same letters referring to the respective machining tools of different spindles which are arranged on the tool magazine disc and which are each simultaneously exchanged, respectively replaced. The presented arrangement makes it possible here to arrange the two spindles comparatively close to each other, with a small distance (see FIG. 1).

Alternatively an arrangement like abcdefg abcdefg is possible, the middle distance between the respectively matching tool pairs being clearly larger. The result of that is a larger distance between the two spindle axes. Additionally it is referred to FIG. 3.

The arrangement is here, according to the invention, chosen in such a way that the distance of the spindle axes is such that on the tool magazine disc between the tool tongs available each time for a tool change process one or more other tool tongs are provided. By means of that the space available on the tool magazine disc is used optimally, with respect to the present work spindles.

In another modification of the invention it is provided that the machine tool has two tool magazine discs and a first tool magazine disc is provided for a first group of several work spindles, and a second tool magazine disc is provided for a second group of several work spindles, and the tool tongs are arranged on the tool magazine discs in different circles, and the tongs axis forms an acute angle with the connection line between the rotational axis of the tool magazine disc and the tool axis of the machining tool resting in the tool tongs. This modification according to the invention is shown, for example, in FIG. 4. The suggestion realises an arrangement of tool tongs on the tool magazine discs in two or more circles. Here basically a larger number of tools can be stored. The particular advantages of this feature are referred to. Furthermore it is also a result of this arrangement that the connection line of the tool tongs of two machining tools which are arranged in the respective tool tongs and which are suited to be exchanged simultaneously in the work spindles, is rectangular to the tongs axes of the respective tool tongs. The design makes a very simple exchange possible as the relative movement can be derived from the linear movement of the tool magazine disc.

It can be seen clearly in the figure that the distance of the two headstocks is less than the distance of the respective rotational axis of the tool magazine discs. The slightly tilted arrangement of the tongs axes makes it possible to change in one linear movement of the two tool magazine discs the tools on four spindles altogether which are orientated relatively close to each other. The advantage of time in this change procedure is considerable.

It is convenient that the spindle axis is orientated parallel to the rotational axis. This produces relatively simple geometric proportions. The same goes also for the arrangement according to another modification of the invention according to which the tool axis of the machining tool held in the tool tongs is parallel to the rotational axis.

In the embodiments which still have to be discussed it is shown that the tool magazine discs are arranged on the machine column which also carry the work spindles. Of course, also another design is possible, namely in such a way that these are held by a column which is opposite, that means located on the opposite side. It may also be provided in a modification that the tool magazine discs dive below the work spindles in a waiting position. However, it is an advantage if the tool magazine discs, as provided in another modification according to the invention, are arranged above the work spindles as, by means of that, their access is improved.

In another aspect of the invention it has been found that the density of machining tools can be increased, in particular by an advantageous design of the tool tongs.

Tool tongs of the known type are designed in such a way that they have at least one contact sickle bent like a half-circle which interacts with the machining tool which has to be picked up in its rotational symmetric shank region, and the tool tongs has furthermore a holding device for holding the machining tool. In order to solve the problem according to the invention, that is to achieve a density of tools as high as possible in the tool magazines, respectively the tool magazine discs; it is suggested that the end regions of the contact sickle recede relatively to the half-circle of the shank. The only possible loading and unloading direction here corresponds at the same time with the orientation of the tongs axis in this known tool tongs. Known contact sickles embrace in an angle region of 180° a receiving opening in which half of the shank region of the machining tool submerges. The result from that is a single direction in which the tool tongs can be loaded, respectively unloaded, with the machining tools. That is rectangular to this diameter. In order to be able to offer machining tools even in complicated arrangements of work spindles such an embodiment would interfere, respectively would require to turn the known tool tongs around a large angle.

However, if according to this solution of the problem of the invention the end region of the contact sickle is set back, the result will be a plurality of different directions how the tool tongs can be loaded and unloaded. Instead of a fixed direction which coincides with the tongs axis a complete angle field will open, each time depending on the design of the end region of the contact sickle in which the tool tongs can be loaded and unloaded reliably.

This suggestion here does not only offer the advantage for the compensation of different directions of the relative movement. At the same time this arrangement compensates even an error so that the exact guide and positioning of the machining tools is not decisive anymore here. Therefore the arrangement according to the invention makes it possible to do with a small effort in this region as the arrangement is able to compensate production tolerances without questioning the practical use.

In a preferred embodiment of the invention it is provided that the holding device is designed as holding sickle, and the holding sickle is in contact with the shank. As a rule, the holding device is used when the machining tool has to be held in the tool tongs. Here the holding device may be designed as a mechanically active flap, the flap then having the design of a holding sickle, or it maybe designed, in another modification of the invention, for example as magnetically active arrangement or equipped with locking bolts and the like.

A preferred modification of the invention provides that on the end region of the holding sickle holding catches are provided which engage in a holding way in a recess provided on the machining tool. Such an arrangement can be controlled easily mechanically and requires small expenses.

In order not to restrict the large variability in the orientation of the relative movement it is convenient that the end regions of the holding sickle are set back relatively to the half-circle of the shank. This suggestion follows basically the same idea as the arrangement of the contact sickle. It is favourable here that the recess on the machining tool has a suitable extension in order to guarantee, nevertheless, that the holding catch of the end region, even if the end region of the holding sickle is set back, engages there reliably.

It is another advantage if the holding sickle is designed to be folded around a folding axis, in particular as spring supported, folding holding sickle. Such a design can be manufactured very easily and mechanically reliably. In another embodiment of the invention it is provided that on the contact sickle an orientation pin is provided which is in particular flattened and which interacts with an orientation nick of the machining tool. The arrangement of an orientation pin in an orientation nick serves as protection against twisting in order to make sure that the machining tool is orientated correctly, in particular held by the tool tongs with reference to a point-symmetry or reflexion-symmetry.

The flattening of the orientation pin has the reason in the large range of possible directions of the relative movement and does not interfere with them.

It is an advantage if the contact sickle, respectively the holding sickle, covers an angle range of 40° to 170°, preferably 120° to 160°, in particular from 135° to 145°. Depending on the design of this angle range where the machining tool sits close to the contact sickle, eventually the angle range results in which the machining tool can be loaded or unloaded in the tool tongs. Conveniently here a symmetric design is striven for so that the receding of the respective end regions is shared equally and may be between 5° and 10° per side. Good results are reached with an angle of about 10° to 30°, in particular at about 20°, as here, on the one hand, a good possibility for fastening may be realised and, on the other hand, a high variability is provided for the direction of loading and unloading the tool tongs. As described also the holding sickle has in a modification an according design, however, this may not be necessarily the same design as the one of the contact sickle, but it has to be seen alternatively. It is, in particular possible, to design a foldable holding sickle in such a way that it does not deviate from the design of the contact sickle, however, does not interfere with it, as the holding sickle is folded away during the loading and unloading process.

Several modifications are provided for the design of the end regions of the holding sickle. The end regions may, for example, end abruptly, or, as described in another variant according to the invention, they may drift tangentially to the tool axis of one of the machining tools held in the tool tongs. In such a design this tangent would support on a certain range guiding the introducing or removal of the machining tool in the tool tongs.

In this connection it belongs also to the scope of the invention that, of course, this tangent can be guided beyond the half-circle. As, however, this region projecting tangentially does no more come close to the shank of the machining tool, if it is held by the tongs, this solution is described identically with the arrangement where the contact region of the contact sickle is set back, and does therefore no more offer a contact possibility.

### BRIEF DESCRIPTION OF THE DIFFERENT VIEWS OF THE DRAWINGS

The invention is shown in drawing schematically.

In the figures:

FIGS. 1 to 8 each a front view of different modifications of the machine tool according to the invention,

FIG. 9 a top view of a tool tongs according to the invention.

### DETAILED DESCRIPTION OF THE PREFERRED EMBODIMENT

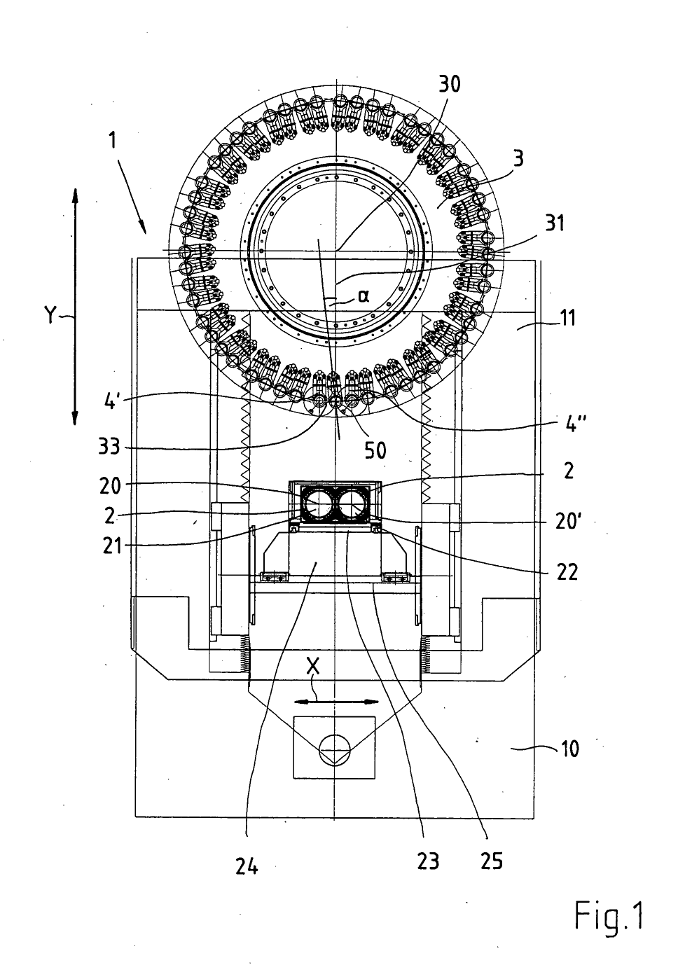

In FIG. 1 a first modification of the machine tool 1 according to the invention is shown. The machine tool 1 is formed by a machine bed 10, along which in upward direction the machine column 11 extends. The work spindles 2 rest on the machine bed 10. In the example shown here two work spindles are indicated, a first work spindle 21 and a second spindle 22. The two spindles 21, 22 are imbedded in a headstock 23, and can be shifted by the slides 24 on a guide path 25 in X-direction.

Reference number 20 indicates the spindle axis of the work spindle 2.

In the example shown here a tool magazine disc 3 is provided which is arranged above the work spindle 2.

It is an advantage that the tool magazine disc 3 is designed in such a way that it can be shifted here vertically along the drawn Y-axis. By means of this an accordingly expensive compound rest guide in the work spindle can be done without. In order to reach the Y-movement of the tool magazine disc a guide is provided, and the tool magazine disc 3 is able to be moved and positioned on it accordingly. The result is that the tool magazine disc 3 is arranged above the work spindles 2, and the relative movement for exchanging and replacing the machining tools 5 is derived from this linear movement.

On the tool magazine disc a plurality of tool tongs 4, here grouped in pairs, are arranged. These tool tongs 4 are orientated essentially radially to the rotational axis 30 of the tool magazine disc 3. The tongs axis 40 of the tool tongs 4 has a certain tilting angle alpha. This tilting angle alpha extends, on the one hand, between the tongs axis 40 and, on the other hand, up to the connection line between the rotational axis 30, the tool magazine disc 3 and the tool axis 50 of the machining tool resting in the tool tongs 4.

In each case the large number of tool tongs can be seen clearly which are available for exchange. The arrangement here is done in such a way that the connection line 33 of the tool axes of two machining tools, which each are arranged in the respective tool tongs 4′ and 4″ is rectangular to the respective tongs axes of the respective tool tongs 4′, 4″. In this case of the arrangement the tongs axis 40 is parallel to the direction of movement Y of the tool magazine disc. It can also be seen clearly that the distance of the tool axes in the concerned tool tongs 4′, 4″ corresponds just with the distance of the spindle axes 20, 20′.

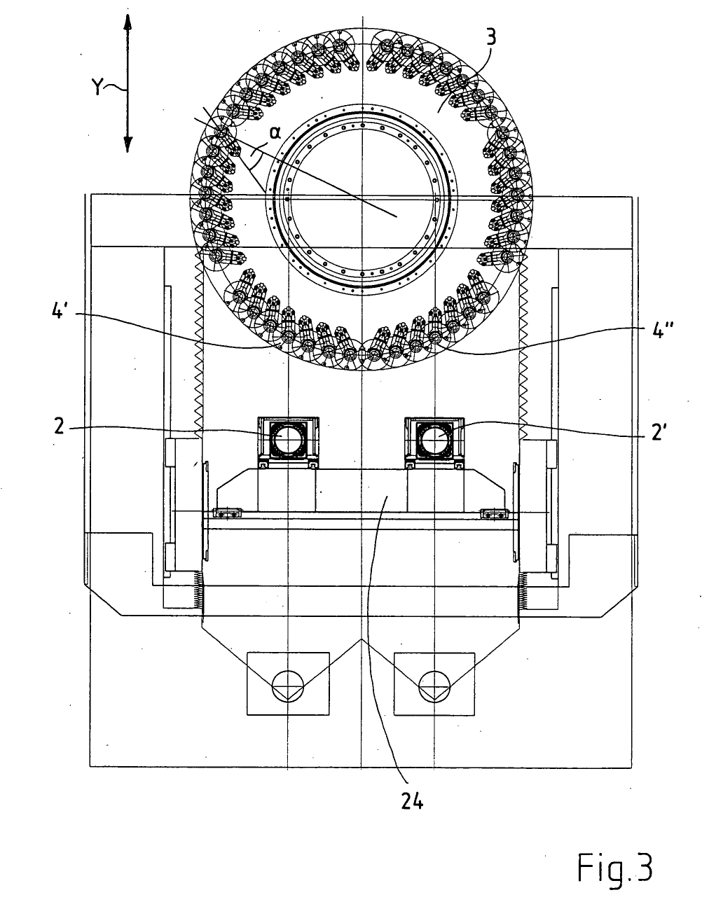

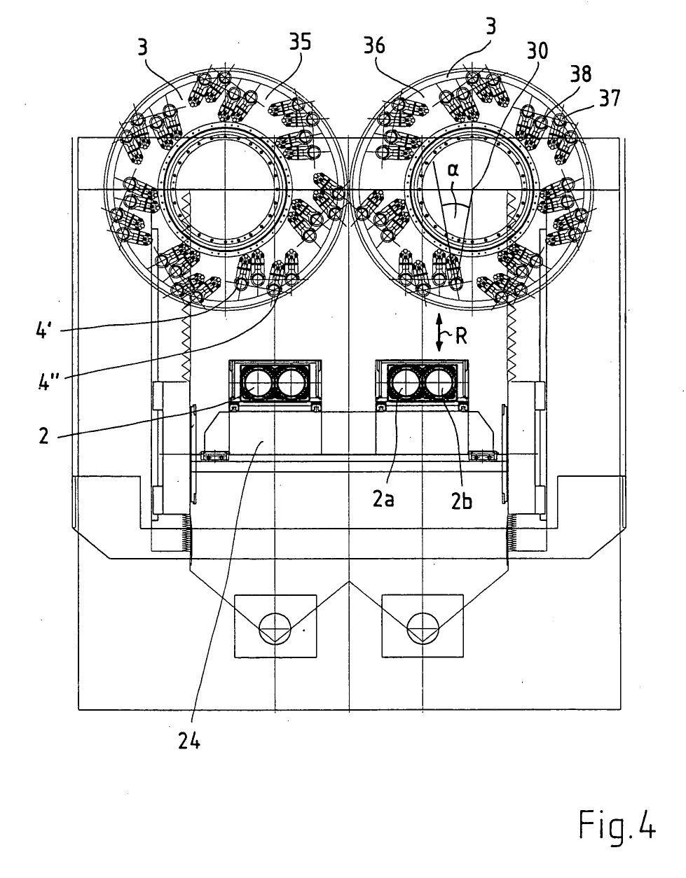

In a preferred embodiment of the invention it is provided that the angle alpha between the tongs axis and the rotational axis 30—tool axis 50 is acute, in particular within an interval of 0:1° to 35°, preferably within the interval of 50 to 35°. For example, FIG. 1, FIG. 3, FIG. 4 show different modifications how this acute angle is realised. However, it is possible in every case to arrange a large number of tool tongs on the tool magazine disc 3.

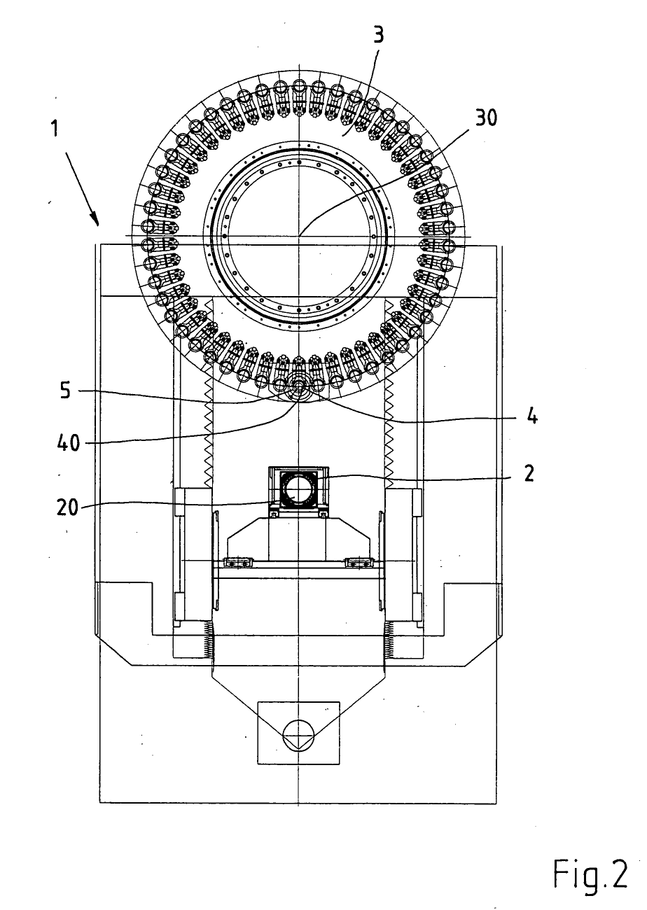

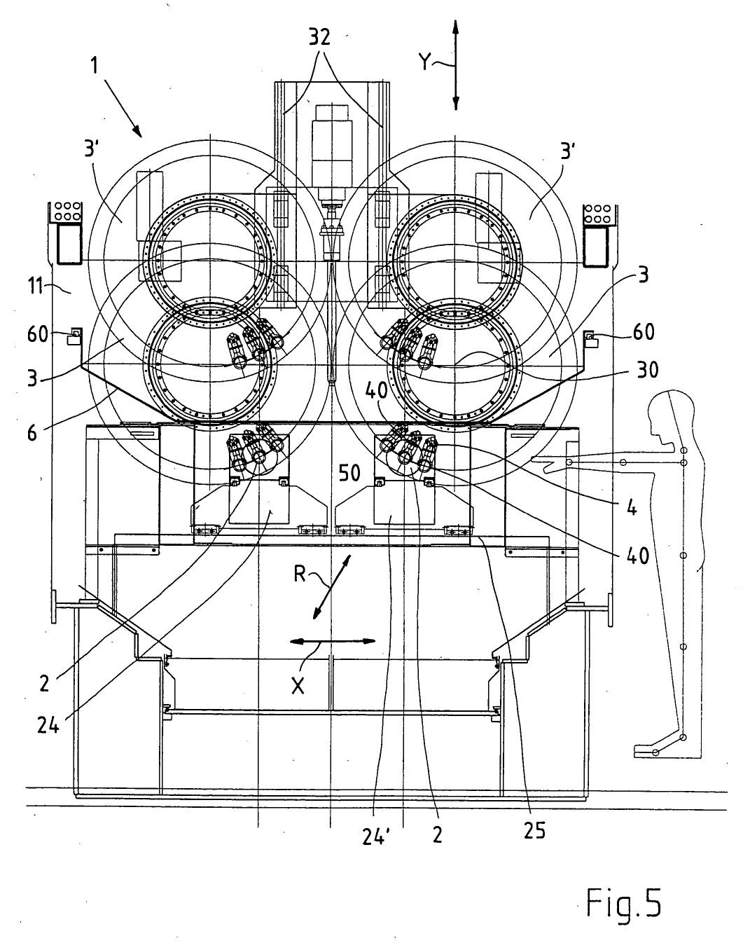

FIG. 2 shows that a tool magazine disc 3 with radially arranged tool tongs 4, as it is then used for example also in FIG. 5, can also be used in a very simple machine, namely as tool supply for only one spindle. This tool supply is formed here only by this one tool magazine disc.

In contrast to the embodiment in FIG. 1, in FIG. 3 the tilting angle alpha is larger and also different. The reason for that is finally that in the modification according to the invention shown in FIG. 3 two spindles 2, 2′ with a larger distance have to be supplied by one tool magazine disc.

Again the two spindles 2, 2′ can be shifted on a common guide path 24, for example a slide. As, however, the distance between the spindles 2, 2′ is clearly more, it is possible to arrange a larger number of other machining tools between the parallel orientated tool tongs 4′, 4″. Eventually the tool magazine disc 3 has to be positioned in the way now shown in FIG. 3, that is the respective chosen pair of tools has to be positioned exactly above the respective spindles in order to exchange, respectively replace, the tool then after lowering the tool magazine disc 3 along the direction Y by a relative movement.

As the construction of the different machine tools according to the modifications shown in the different figures is essentially always the same, in the following a repetition of the respective identical components is left out. Rather the essential differences are pointed out.

In FIG. 4 another modification of the invention is shown. In the example shown here two times two spindles 2 are provided. The machine is constructed essentially symmetric. The four overall spindles (it is also called a four-spindle machine) are combined in two spindle groups each with two work spindles 2.

The four spindles, respectively two spindle groups with two work spindles each, are on a common guide path 24, for example a slide and can be moved again in X-direction.

In this embodiment two tool magazine discs are provided. The one on the left hand side is indicated by 35, the tool magazine disc on the right hand side is indicated by reference number 36. The left spindle group is assigned here to the tool magazine disc 35, the right one to the tool magazine disc 36.

The tow tool magazine discs 35, 36 can be shifted vertically by means of one or two guides. By means of that the tool magazine discs 35, 36 are tilted towards the work spindles 2. Thus in a change process up to 4 tools altogether are exchanged, respectively replaced.

In order to achieve this, the respective interacting pairs of tool tongs 4, 4′ are, similar as in the solution according to FIG. 3, orientated to each other parallel.

As two work spindles 2 have to be supplied simultaneously with tools eventually the tool tongs 4 are in two different circles 37, 38. The circles 37, 38 are arranged here concentrically around the rotational axis 30. The arrangement is chosen here in such a way that the exterior circle 37 supplies the tool tongs 4, which are meant for the spindle 2a, which is at a larger distance to the rotational axis 30 then the adjacent spindle 2b. The spindle 2b is supplied with tools by the tool tongs of the interior circle 38. Basically this arrangement can be extended also to arrangements where instead of two spindles per spindle group three, four or even more spindles are provided.

While in the FIGS. 1 to 4 the relative movement R was parallel to the linear movement Y of the respective disc magazine, the situation in the modification according to FIG. 5 is different.

In the example shown in FIG. 5 two tool magazine discs 3 are provided which are shown in two different positions, the arrangement in waiting position being indicated by 3′, and the position, where the tool magazine disc is in the bottom change position, by 3. In order to position it the tool magazine disc 3 is positioned each time on a guide 32. The tool magazine discs can be positioned together or independently of each other. In the example shown here to one tool magazine disc 3 each time only one work spindle 2 is assigned. Therefore all tools necessary for that, respectively all tool tongs, are arranged in a concentric circle.

In contrast to the example of the embodiment according to FIG. 2 where the rotational axis 30, the tool axis 40 and the spindle axis 20 form a straight line which extends vertically and which is also parallel to the linear movement of the tool magazine disc, there is an angle here between these two orientations.

In other words the relative movement R is not parallel to the linear movement Y by means of which in the modifications according to FIGS. 1 to 4 before the relative movement R has been derived.

The reason is that the work spindles 2 are no more positioned below the rotational axis 30, but each time towards the interior of the machine.

In a modification according to the invention, however, it is now suggested that the relative movement results from an interference of at least two movements, for example the tool magazine disc 3 and the tool spindle 2. In the example shown here the spindles 2 each are on their own slide 24, 24′, and can be moved on the guide path 25 in X-direction. The linear movement Y of the tool magazine disc 3 extends rectangular to it. When these two movements interfere cleverly a relative movement R as indicated results. That means the tongs axis 40 is again parallel to this relative movement R, although no movement component is offered parallel to the relative movement R. This makes it possible to position, in a simple way, and in particular using double the already present elements, work spindles 2 closely, and to provide nevertheless a large number of machining tools 5 in the respective tool magazine discs.

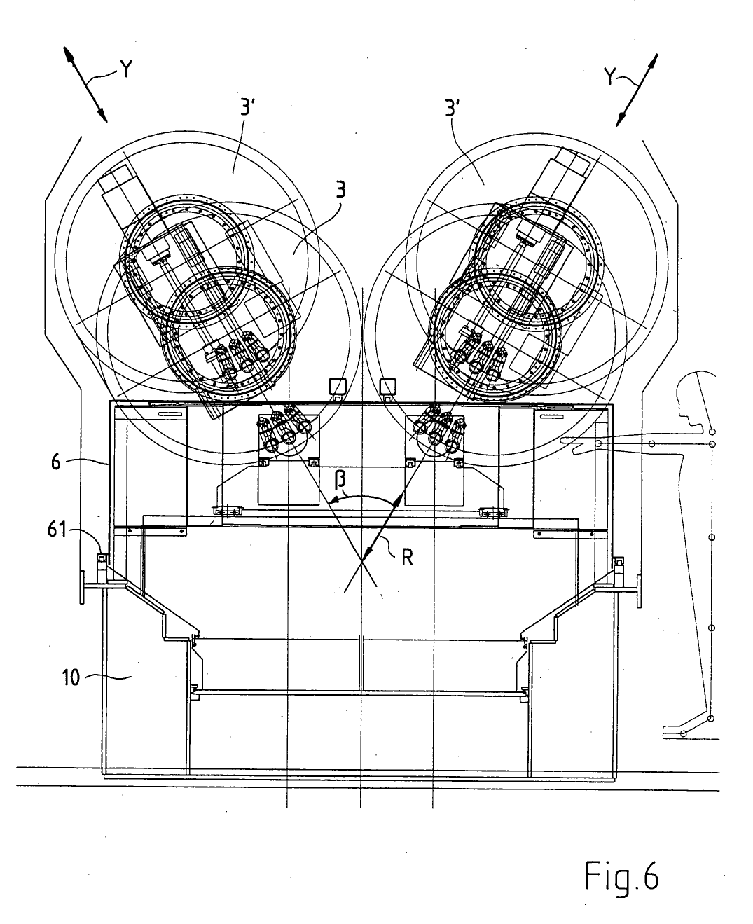

Similar to FIG. 5 also FIG. 6 shows an arrangement where two tool magazine discs 3 (again shown in two positions) supply only two work spindles 2 with tools. However, here the linear movement Y is again parallel to the relative movement R. The result is, however, a V-like design of the guide paths, respectively the respective linear movements Y and Y′ of the left and right tool magazine disc 3. They cut at an acute angle beta. An interference of the movements is not necessary, therefore the spindles 2 are again arranged on a common slide 24.

In an advantageous embodiment of the invention it is provided that the work spindles 2 are arranged in the working area of the machine tool, and a tool magazine door 6 is provided which can be opened for the tool change process in order to bring the tool magazine disc(s) in the region of the work spindle(s) 2. For that purpose two modifications are shown in FIG. 5, respectively FIG. 6. In FIG. 5 it is shown that the tool magazine door 6 is arranged suspended, in particular shifting on the machine column 11. For that the guide rail 60 is provided. In FIG. 6, in contrast to that, the other variant is shown where the tool magazine door is designed portal-like, supported by the machine column 10. For that purpose, if necessary, on the machine column 10 guide rails 61 are provided. The design of the tool magazine door 6 in FIG. 5 is groove-like, the design in FIG. 6 is portal-like, covering the spindles.

To prevent the construction of the tool magazine doors 6 from becoming to large and thus inconvenient it is provided in another modification according to the invention that the tool magazine door 6 consists of several door elements in the way of a telescope which, on the other hand, are designed either suspended or movable in a supporting manner.

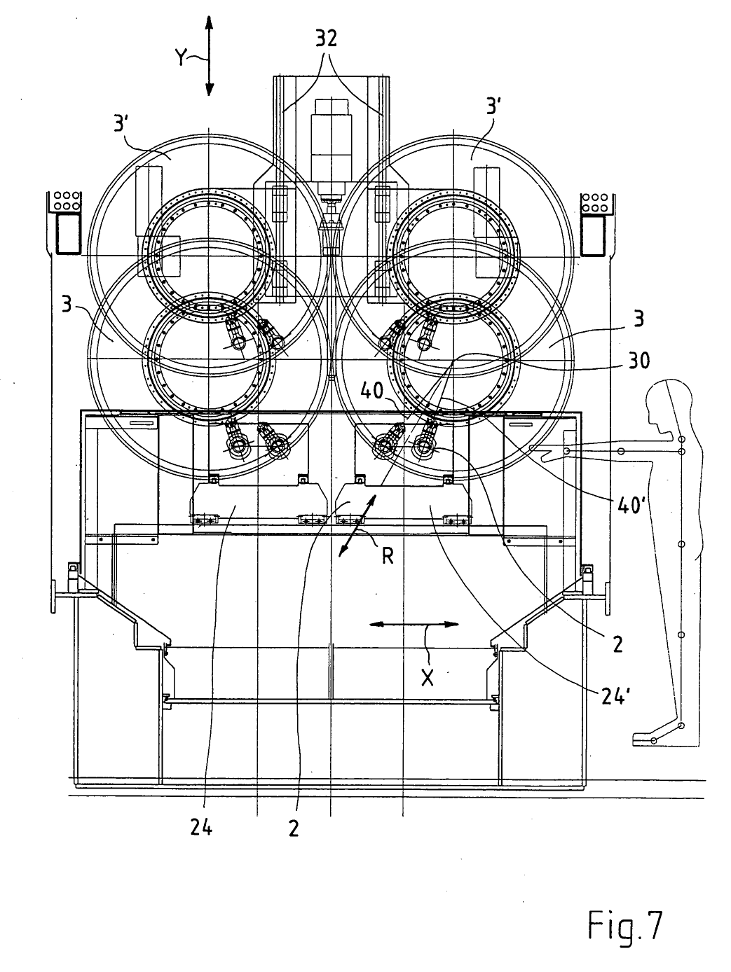

The situation shown in FIG. 7 is similar to the modification according to the invention already presented in FIG. 5. Here also only the differences are pointed out in order to avoid repetitions. In contrast to the solution according to FIG. 5 here two spindle groups with two spindles each are provided which have to be supplied with tools by one tool magazine disc 3 each.

In the center between the two tool magazine discs a central linear drive is provided which makes the linear movement in Y-direction (here vertically) possible. For each spindle group again an individual slide 24, 24′ is provided.

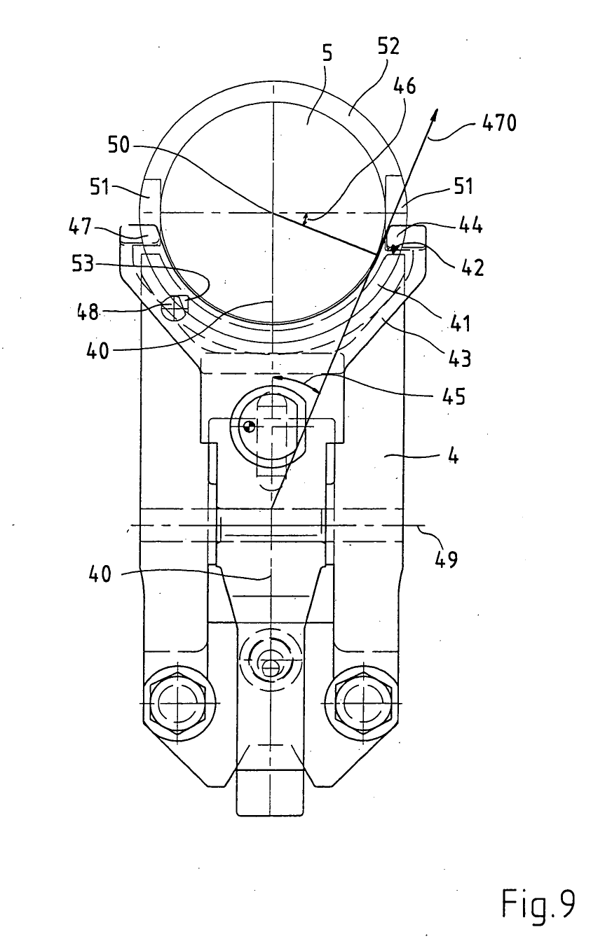

It can be seen now that the tongs axis 40, which is orientated radially to the rotational axis 30, is, in the embodiment shown in FIG. 7, no more parallel to the relative movement R. The relative movement R is rather orientated in such a way that it extends between two tongs axes 40, 40′, for example as bisecting line of the angle. Finally the tools are loaded or unloaded with a certain angle error simultaneously at the spindles 2 of a spindle group in the tool tongs 4, and provisions have to be taken to compensate this angle error, that is the deviation of the orientation of the relative movement R with respect to the tongs axis 40, 40′. For that purpose serves a special design on the tool tongs 4 which, in particular, will be discussed in FIG. 9.

In order to reach again out of the rectangular to each other orientated linear movement Y and the spindle movements X the relative movement R, which is diagonally to it, these two components of movement are interfered in a clever way. The angle error which remains nevertheless is small and identical because of the bisecting line of the angle as direction of the relative movement.

In another modification according to the invention it is suggested to carry out the relative movement R through interference of the linear movement Y and a rotational movement of the tool magazine disc 3 in order to reach their rotational axis 30. By means of this, with respect to the relevant points, namely the concerned tool tongs 40, 40′, also a component of movement arises which is orthogonal to the linear movement Y, and which can be cleverly combined in such a way that the diagonally orientated relative movement arises. It can be seen clearly that by means of such an arrangement a comparatively close distance is possible either of the individual spindles or even the spindle groups on their independent slide 24, 24′. The space between the two tool magazine discs 3 is used cleverly. Eventually this results in a smaller construction width of the machine tool according to the invention.

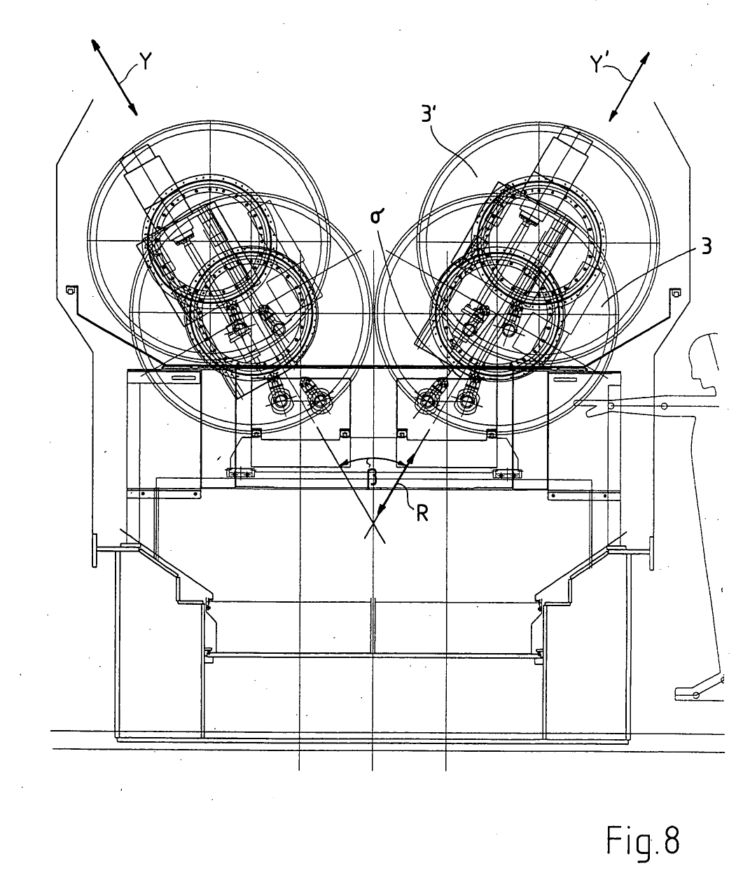

In the same way as the arrangements of FIGS. 7 and 5 are similar, also the arrangements of FIGS. 6 and 8 are relatively similar. In FIG. 8 again the linear movements Y, Y′ of the two tool magazine discs are directed towards each other in V-shape. They cut each other below the respective tool magazine discs at the angle beta. Again there is an angle error sigma between the connection line of the spindle axis 20 of the work spindle 2 and the rotational axis 30. This angle error is compensated by an advantageous design of the tool tongs. As in FIG. 6 also in FIG. 8 the relative movement R is derived from the linear movement Y.

In FIG. 9 the tool tongs also belonging independently to the invention are shown. The tool tongs 4 have a bent contact sickle 41 interacting with the machining tool 5, which has to be picked up, in its rotational symmetric shank region 52. The tool tongs 4 have furthermore a holding device which makes sure that the machining tool does not fall out of the tool tongs. The holding device is, in the example shown here, designed as holding sickle 43. In the chosen view the contact sickle 41 is concealed by the holding sickle 43. Therefore the contact sickle 41 is shown with a dashed line.

In order to achieve that the exchanging and replacing of the tools, in particular in the embodiments according to FIGS. 7 and 8 can be carried out without any problems, the angle between the relative movement R and the tongs axis 40 has to be taken into consideration. In the known tool tongs the tool was loaded or removed in the tongs parallel to the tool axis 40. In order to compensate this “error” it is suggested according to the invention that the end regions 42 of the contact sickle are set back relatively to the half-circle of the shank 52. This angular setting back is indicated by reference number 46. In this example it is about 20°.

The invention provides furthermore that the holding device is designed as holding sickle 43, and that the holding sickle 43 has contact to the shank 52.

The machining tool 5 has diametrically arranged recesses 51, into which holding catches 47 provided at the end regions 44 of the holding sickle 43 engage in a holding way.

This end regions 44 of the holding sickle 43 are also set back relatively to the half circle 52. This receding distance corresponds with the same angular receding distance as for the end region 42 of the contact sickle 41. Additionally, however, in the invention it is also provided that the end regions of the holding sickle 43 drift tangentially 47 to the tool axis 50 of the machining tool 5 held in the tool tongs. The orientation of this tangent 470 is elongated in the drawing of FIG. 9 in such a way until it cuts the tongs axis 40. Reference number 45 indicates the angle error existing between the tangent 470 and the tongs axis 40. Until up to this angle error 45, by means of the tool tongs according to the invention, tools may be conveyed in or out without any problems. The use of these tool tongs in the arrangements according to FIGS. 7 and 8 make it therefore possible to compensated the angle error resulting there, and to achieve a quick change of the machining tools on the machine tools according to the invention.

The holding sickle 43 is designed in such a way that it can be folded around the folding axis 49.

The angle error field 45 realised here is, for example, 25°. The symmetric design has to be taken into consideration, because of which the actual field is +/−25°. Depending on the design of the angular distance 46 of course this angle error can be adjusted.

In order not to disturb the free introducing of the machining tool 5 in the tool tongs 4 not even by the known orientation pins, the orientation pin 48 is flattened and thus engages in the orientation nick 53 of the machining tool 5.

As far as a spindle has been described it is the same as a work spindle.

Although the invention has been described by exact example which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Machine tool with only one work spindle which carries and drives a machining tool which can be exchanged, as well as a tool supply which has tool tongs for receiving machining tools, a relative movement being provided between tool magazine and work spindle for exchanging, respectively replacing, of machining tools on the work spindle, characterized in that the tool supply is shared out between at least two part magazines.

2. Machine tool according claim 1, characterized in that the part magazine(s) is/are designed as tool magazine disc (3) rotating around a rotational axis (30).

3. Machine tool according to claim 1, characterized in that the work spindle is designed movable in such a way that it can reach the respective part magazines.

4. Machine tool according to claim 1, characterized in that the part magazines are designed in such a way that they can be shifted and brought to the work spindle, in particular be brought for a tool change.

5. Machine tool according to claim 1, characterised in that the part magazines are arranged above the work spindle.

6. Machine tool according to claim 1, characterised in that at least one tool magazine disc is provided which carries the tool tongs, and the tongs axis of the tool tongs is arranged radial on the respective tool magazine disc, respectively the tongs axis forms with the connection line between the rotational axis of the tool magazine disc and the tongs axis of the machining tool resting in the tool tongs an acute angle alpha.

7. Machine tool according to claim 1, characterised in that the machine tool has two tool magazine discs (3) which carry the tongs, and the tool magazine discs (3) are located close to each other at least in the tool change position for exchanging, respectively replacing, machining tools.

8. Machine tool according to claim 1, characterized in that the machine tool has two tool magazine discs (3) which carry the tongs, and the two rotational axes (30) of the two tool magazine discs (3) are orientated parallel, and the two tool magazine discs (3) are in one plane.

9. Machine tool according to claim 1, characterized in that the machine tool has two tool magazine discs (3) which carry the tongs, and the two rotational axes (30) of the two tool magazine discs (3) are orientated parallel, or two tool magazine discs (3) are in one plane.

10. Machine tool according to claim 1, characterized in that the machine tool has two tool magazine discs (3) which carry the tongs, and for the tool magazine discs (3) a guide (32) is provided, along which the tool magazine disc (3) can move linear in a linear movement (Y), and can be brought to the work spindle (2) in a tool change position.

11. Machine tool according to claim 1, characterized in that several tool magazine discs (3) are provided which can be moved in a common guide (32) similarly.

12. Machine tool according to claim 1, characterised in that several tool magazine discs (3) are provided and can be moved independently of each other.

13. Machine tool according to claim 1, characterised in that several tool magazine discs (3) are provided, and can move independently of each other, and each of several tool magazine discs (3) has its own guide (32), and the respective directions of movement form with each other an angle beta, in particular an obtuse or acute angle beta.

14. Machine tool according to claim 1, characterised in that at least one tool magazine disc is provided which carries the tool tongs, and the tool magazine disc (3) is designed like a ring and has a rotational drive.

15. Machine tool according to claim 1, characterised in that at least one tool magazine disc is provided which carries the tool tongs, and the tool magazine disc (3) is designed a polygon.

16. Machine tool according to claim 1, characterised in that at least one tool magazine disc is provided which carries the tool tongs, and the tool tongs (4) are arranged in a circle concentrically around the rotational axis (30) of the tool magazine disc designed as part magazine.

17. Machine tool according to claim 1, characterised in that at least one tool magazine disc is provided which carries the tool tongs, and in the tool change position for exchanging, respectively replacing, machining tools the spindle axis (20) of the work spindle (2) and the rotational axis (30) of the tool magazine disc designed as part magazine form a straight line parallel to the linear movement.

18. Machine tool according to claim 1, characterised in that at least one tool magazine disc is provided which carries the tool tongs, and in the tool change position for exchanging, respectively replacing, machining tools the connection line of spindle axis (20) of the work spindle (2) and the rotational axis (30) of the tool magazine disc designed as part magazine forms an acute angle sigma with the linear movement.

19. Machine tool according to claim 1, characterised in that at least one tool magazine disc is provided which carries the tool tongs, and a relative movement (R) between tool magazine disc and work spindle for exchanging, respectively replacing, machining tools results from an interference of at least two movements, for example of the tool magazine disc (3) and the work spindle (2).

20. Machine tool according to claim 1, characterized in that at least one tool magazine disc is provided which carries the tool tongs, and a relative movement (R) between the tool magazine disc and work spindle for exchanging, respectively replacing, machining tools results from an interference of at least two movements, for example of the tool magazine disc (3) or the work spindle (2).

21. Machine tool according to claim 1, characterized in that at least one tool magazine disc is provided which carries the tool tongs, and a relative movement (R) between tool magazine disc and work spindle for exchanging, respectively replacing, machining tools results from an interference of the linear movement (Y) of the tool magazine disc (3) and a linear movement (X) of the work spindle (2).

22. Machine tool according to claim 1, characterised in that at least one tool magazine disc is provided which carries the tool tongs, and a relative movement (R) between tool magazine disc and work spindle for exchanging, respectively replacing, machining tools results from an interference of the linear movement of the tool magazine disc (3) and a rotation of the tool magazine disc (3) around its rotational axis (30).

23. Machine tool according to claim 1, characterised in that the work spindle (2) is supported in a headstock.

24. Machine tool according to claim 1, characterized in that the work spindle (2) can be moved, respectively positioned, along a guide path (24) in a linear movement (X) of the spindle, in particular with the help of a headstock.

25. Machine tool according to claim 1, characterised in that a tool magazine disc (3) supplies the work spindle with machining tools.

26. Machine tool according to claim 1, characterized in that at least one tool magazine disc is provided which carries the tool tongs, and the tool tongs (4) are arranged in the tool magazine disc (3) in two or more circles (37, 38).

27. Machine tool according to claim 1, characterized in that a relative movement (R) is orientated in the space between the tongs axes (40) of the tool tongs (4) which are in tool change position with reference to the work spindle.

28. Machine tool according to claim 1, characterized in that the work spindle (2) is arranged in a working area of the machine, and a tool magazine door (6) is provided which can be opened for exchanging, respectively replacing, the machining tools, in order to bring the tool magazine disc (3) in the region of the work spindle (2).

29. Machine tool according to claim 1, characterised in that the work spindle (2) is arranged in a working area of the machine, and a tool magazine door (6) is provided which can be opened for exchanging, respectively replacing, the machining tools, in order to bring the tool magazine disc (3) in the region of the work spindle (2), and the tool magazine door (6) is arranged suspended, in particular shifting on a machine column (11).

30. Machine tool according to claim 1, characterized in that the work spindle (2) is arranged in a working area of the machine, and a tool magazine door (6) is provided which can be opened for exchanging, respectively replacing, the machining tools in order to bring the tool magazine disc (3) in the region of the work spindle (2), and the tool magazine door (6) is designed like a portal, which is in particular supported by a machine table.

31. Machine tool according to claim 1, characterised in that the work spindle (2) is arranged in the working area of the machine, and a tool magazine door (6) is provided which can be opened for exchanging, respectively replacing, the machining tools in order to bring the tool magazine disc (3) in the region of the work spindle (2), and the tool magazine door (6) can be opened, respectively be moved for closing, essentially parallel to the rotational axis (30).

32. Machine tool according to claim 1, characterised in that the work spindle (2) is arranged in a working area of the machine, and a tool magazine door (6) is provided which can be opened for exchanging, respectively replacing, the machining tools, in order to bring the tool magazine disc (3) in the region of the work spindle (2), and the tool magazine door (6) consists, like a telescope, of several door elements.

33. Machine tool according to claim 1, characterised in that the connection line of the tool axes (50) of two machining tools (5) which are arranged in their respective tool tongs (4) is rectangular to the tongs axis (40) of the respective tool tongs (4).

34. Machine tool according to claim 1, characterized in that at least one tool magazine disc is provided which carries the tool tongs, and the tongs axis of the tool tongs is arranged radial in the respective tool magazine disc, respectively the tongs axis forms with the connection line between the rotational axis of the tool magazine disc and the tool axis of the machining tool resting in the tool tongs an acute angle alpha, and the acute angle alpha is in an interval of 0.1° to 35°, preferably between 5° and 35°.

35. Machine tool according to claim 1, characterized in that the spindle axis (20) is orientated parallel to the rotational axis (30).

36. Machine tool according to claim 1, characterised in that the tool axis (50) of the machining tool (5) held in the tool tongs (4) is parallel to the rotational axis (30).

37. Machine tool according to claim 1, characterized in that at least one tool magazine disc is provided which carries the tool tongs, and the tool magazine discs (3) are arranged above the work spindle (2).

38. Tool tongs for tool magazine discs in machine tools, the tool tongs having at least one bent contact sickle which interacts with the received machining tool in its rotational symmetric shank region, and the tool tongs having furthermore a holding device for holding the machining tool in the tool tongs, characterized in that the end regions (42) of the contact sickle (41) are set back versus the half circle of the shank.

39. Tool tongs according to claim 38 for tool magazine discs in a machine tool with only one work spindle which carries and drives a machining tool which can be exchanged, with a tool supply which has tool tongs for receiving machining tools, a relative movement being provided between tool magazine and work spindle for exchanging, respectively replacing, machining tools on the work spindle, and the machine tool is characterised in that the tool supply is shared out between at least two part magazines.

40. Tool tongs according to claim 38, characterised in that the holding device is designed as holding sickle (43), and the holding sickle (43) is in contact with the shank (52).

41. Tool tongs according to claim 38, characterised in that the holding device is designed as holding sickle (43), and at the end regions (44) of the holding sickle (43) holding catches (47) are provided, which engage in a holding way into recesses (51) provided in the machining tool (5).

42. Tool tongs according to claim 38, characterised in that the holding device is designed as holding sickle (43), and the end regions (44) of the holding sickle (43) are set back versus the half circle of the shank (52).

43. Tool tongs according to claim 38, characterised in that the holding device is designed as holding sickle (43), and the holding sickle (43) is designed in such a way that it can be folded around a folding axis (49), in particular folded supported by a spring.

44. Tool tongs according to claim 38, characterised in that the holding device is designed as holding sickle (43), and the holding sickle (43) is designed in such a way that it can be folded around a folding axis (49), in particular folded supported by a spring, and the folding axis (49) is orientated rectangular to the tongs axis (40).

45. Tool tongs according claim 38, characterised in that on the contact sickle (41) an orientation pin (48) is provided which is in particular flattened and which interacts with an orientation nick (53) of the machining tool (5).

46. Tool tongs according to claim 38, characterised in that the holding device is designed as holding sickle (43), and the holding sickle (43) is in contact with the shank (52), and the contact sickle (41), respectively the holding sickle (43), covers an angle range of 40° to 170°, preferably of 120° to 160°, in particular of 135° to 145°.

47. Tool tongs according to claim 38, characterised in that the holding device is designed as holding sickle (43), and the holding sickle (43) is in contact with the shank (52), and the end regions of the contact sickle (41), respectively the holding sickle (43), are designed similarly, respectively the contact sickle or the holding sickle are designed symmetric to the tongs axis (40).

48. Tool tongs according to claim 38, characterised in that the holding device is designed as holding sickle (43), and the holding sickle (43) is in contact with the shank (52), and the end regions (44) of the holding sickle (43) drift tangentially (470) to the tool axis (50) of a machining tool (5) held in the tool tongs (5).

49. Tool tongs according to claim 38, characterised in that a machining tool (5) can be shifted in or out at an angle interval of an angle error (45) of up to 40°, preferably 25°, into the tool tongs (4).
